(19) United States
(12) Patent Application Publication
(10) Pub. No.: US 2024/0267873 A1
(43) Pub. Date: Aug. 8, 2024

(54) POSITIONING MEASUREMENT WITH LOW LATENCY

(71) Applicant: Sony Group Corporation, Tokyo (JP)

(72) Inventors: Basuki PRIYANTO, Lund (SE); Anders BERGGREN, Lund (SE); Yujie ZHANG, Lund (SE)

(21) Appl. No.: 18/291,542

(22) PCT Filed: Aug. 5, 2022
(86) PCT No.: PCT/EP2022/072109

§ 371 Date: Jan. 23, 2024

(30) Foreign Application Priority Data
Aug. 6, 2021 (SE) 2150988-0

(51) Int. Cl. H04W 64/00; H04W 8/22; H04W 24/10; H04W 76/28

(52) U.S. Cl. CPC H04W 64/00; H04W 8/22; H04W 24/10; H04W 76/28

(57) ABSTRACT

A method of operating a wireless communication device connected to a cellular network is provided. The method comprises establishing one or more pre-configurations of a positioning measurement, and after said establishing of the one or more pre-configurations, establishing a positioning measurement period for performing the positioning measurement. The method further comprises in the positioning measurement period and in accordance with the one or more pre-configurations of the positioning measurement, participating in the positioning measurement.

### TECHNICAL FIELD

Various examples of the disclosure generally relate to positioning of wireless communication devices using positioning signals transmitted by multiple access nodes. Various examples specifically relate to performing a positioning measurement in accordance with one or more pre-defined configurations of the positioning measurement.

### BACKGROUND

To facilitate positioning of wireless communication devices (sometimes also referred to as user equipment, UE), multilateration and multiangulation techniques can be employed. An example of multiangulation is triangulation. Here, multiple access nodes (AN)—having a well-defined position in a reference coordinate system—transmit positioning signals (also referred to as positioning reference signals, PRSs). A UE can receive the PRSs and then trigger a multilateration or multiangulation. One particular technique is observed time-difference of arrival (OTDOA).

OTDOA is, in particular, deployed in Third Generation Partnership (3GPP) cellular networks, such as the Long Term Evolution (LTE) 4G or New Radio (NR) 5G protocols. Here, the UE receives PRSs from multiple base stations (ANs) implementing the ANs and then performs a timing difference of arrival (TDOA) measurement. Results of the TDOA measurements (e.g., Reference Signal Time Difference (RSTD) measurement) are transmitted from the UE to a location server (LS) using a positioning protocol (PP). This is via the 3GPP radio access network (RAN). The LS then performs the positioning estimation based on multilateration and/or multiangulation of at least two or at least three results of the TDOA measurements. See 3GPP Technical specification (TS) 36.305, V15.0.0 (2018-07), section 4.3.2 and/or TS 38.305, V16.0.0 (2020-03), section 4.3.3.

Positioning of the UE may involve two main steps: positioning measurements and position estimate. The positioning measurements may be made by the UE or by the BS (e.g., a gnB, next generation NodeB). In cases of UE-assisted positioning, the LS performs the positioning estimation. In cases of UE-based positioning, the UE performs both the positioning measurements and the positioning estimation.

FIG. 1 is a signaling diagram depicting legacy UE-assisted downlink-based (DL-based) positioning of UE. FIG. 1 illustrates aspects with respect to a legacy PP. The UE initially receives a message on the PDSCH (Physical Downlink Shared Channel) which includes LTE PP (LPP) Location Information Request. After decoding and obtaining the location information request, the UE sends a measurement gap request on the PUSCH (Physical Uplink Shared Channel) as an RRC (Radio Resource Control) message to the serving BS. After obtaining the information, the BS provides measurement gap configuration on the PDSCH as an RRC message. After decoding/obtaining the information, the UE receives or measures the PRSs from typically multiple ANs within the measurement gap. The UE is expected to receive PRSs for at least one positioning occasion (PO) within the measurement gap. Then, the UE also performs positioning measurement, e.g., an RSRP (Reference Signal Received Power) measurement or an RSTD (Reference Signal Time Difference) measurement. The UE positioning measurement is also subject to UE capability, known as the “N, T parameter”. For example, (N, T)=(16, 20) means the UE measures the PRS(s) during a positioning occasion with a length of 16 ms, and the UE requires at least 4 ms to complete the processing of positioning measurement computation (20 ms total minus the 16 ms of measurement time). Once the measurement is completed and ready to be reported to the LMF (Location Management Function) implementing the LS, the UE transmits an uplink request in a PUCCH (Physical Uplink Control Channel) to the serving BS. After decoding/obtaining the information, the serving BS provides an uplink grant in a PDCCH (Physical Downlink Control Channel) to the UE. Finally, the UE transmits the positioning measurement results in a PUSCH as the LPP protocol to the LMF via the serving BS.

Such techniques face certain restrictions and drawbacks. For example, the minimum estimated physical layer latency for 3GPP Release16 downlink-based UE-assisted NR positioning exceeds 100 ms. On the other hand, positioning in 5G NR has more stringent latency requirements than in LTE as it supports some new use-cases, such as industrial/factory automation. A physical layer latency of less than 100 ms is required to support the specific use-cases above. Accordingly, the legacy NR positioning procedure latency is exceeding the requirement of physical layer latency of NR positioning, for example, according to 3GPP Release 17.

### SUMMARY

Therefore, a need exists for advanced techniques of positioning of a UE. In particular, a need exists for advanced techniques of low-latency positioning which overcome or mitigate at least some of the above-identified restrictions or drawbacks.

This need is met by the features of the independent claims. The features of the dependent claims define embodiments.

A method of operating a wireless communication device connected to a cellular network is provided. The method comprises establishing one or more pre-configurations of a positioning measurement, and after said establishing of the one or more pre-configurations, establishing a positioning measurement period for performing the positioning measurement. The method further comprises in the positioning measurement period and in accordance with the one or more pre-configurations of the positioning measurement, participating in the positioning measurement.

A computer program or a computer-program product or a computer-readable storage medium includes program code to be executed by at least one processor. Executing the program code causes the at least one processor to perform a method of operating a wireless communication device. The method comprises establishing one or more pre-configurations of a positioning measurement, and after said establishing of the one or more pre-configurations, establishing a positioning measurement period for performing the positioning measurement. The method further comprises, in the positioning measurement period and in accordance with the one or more pre-configurations of the positioning measurement, participating in the positioning measurement.

A UE includes control circuitry, the control circuitry being configured to: establish one or more pre-configurations of a positioning measurement, and after said establishing of the one or more pre-configurations, establish a positioning measurement period for performing the positioning measurement. The control circuitry is further configured to, in the positioning measurement period and in accordance with the one or more pre-configurations of the positioning measurement, participating in the positioning measurement.

A method of operating a network node of a network is provided. The method comprises establishing one or more pre-configurations of a positioning measurement for a wireless communication device, and after establishing the one or more pre-configurations, providing, to the wireless communication device, a measurement grant comprising a pointer to at least one of the one or more pre-configurations and indicative of a positioning measurement period. The method further comprises, in the positioning measurement period and in accordance with the at least one of the one or more pre-configurations of the positioning measurement, participating in the positioning measurement.

A computer program or a computer-program product or a computer-readable storage medium includes program code to be executed by at least one processor. Executing the program code causes the at least one processor to perform a method of operating a network node of a network. The method comprises establishing one or more pre-configurations of a positioning measurement for a wireless communication device, and after establishing the one or more pre-configurations, providing, to the wireless communication device, a measurement grant comprising a pointer to at least one of the one or more pre-configurations and indicative of a positioning measurement period. The method further comprises, in the positioning measurement period and in accordance with the at least one of the one or more pre-configurations of the positioning measurement, participating in the positioning measurement.

A network node of a network includes control circuitry, the control circuitry being configured to: establish one or more pre-configurations of a positioning measurement for a wireless communication device, and after establishing the one or more pre-configurations, provide, to the wireless communication device, a measurement grant comprising a pointer to at least one of the one or more pre-configurations and indicative of a positioning measurement period. The control circuitry is further configured to, in the positioning measurement period and in accordance with the at least one of the one or more pre-configurations of the positioning measurement, participating in the positioning measurement.

For example, the network node could be a location server or one of the one or more access nodes.

A method of operating a wireless communication device connected to a cellular network is provided. The method comprises establishing one or more configurations of a positioning measurement, and establishing a positioning measurement period for performing the positioning measurement. The method further comprises, in the positioning measurement period and in accordance with the one or more configurations of the positioning measurement, participating in the positioning measurement.

For example, establishing the positioning measurement period may include receiving a measurement grant on the Physical Layer or Medium Access Layer.

In a further example, establishing the positioning measurement period may include providing, to the cellular network, a measurement request on the Physical Layer or Medium Access Layer.

In another example, the one or more configurations are pre-emptively provided to or established at the wireless communication device.

In a further example, the one or more configurations are associated with a low-latency positioning mode, and the method optionally comprises determining whether the wireless communication device supports the low-latency positioning mode.

In a still further example, the one or more configurations are indicative of a measurement gap length and optionally the measurement gap length is shorter than a duration of a resource set of positioning signals of the positioning measurement.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 is a signaling diagram according to the prior art.

FIG. 2 schematically illustrates an exemplary configuration of a measurement gap according to various examples.

FIG. 3 schematically illustrates a cellular network according to various examples.

FIG. 4 schematically illustrates a resource mapping of various channels implemented on a wireless link of the cellular network according to various examples.

FIG. 5 schematically illustrates transmission of PRSs according to various examples.

FIG. 6 schematically illustrates a BS according to various examples.

FIG. 7 schematically illustrates a UE according to various examples.

FIG. 8 schematically illustrates an LS according to various examples.

FIG. 9 is a flowchart of a method according to various examples.

FIG. 10 is a flowchart of a method according to various examples.

FIG. 11 is a signaling diagram according to various examples.

FIG. 12 is a signaling diagram according to various examples.

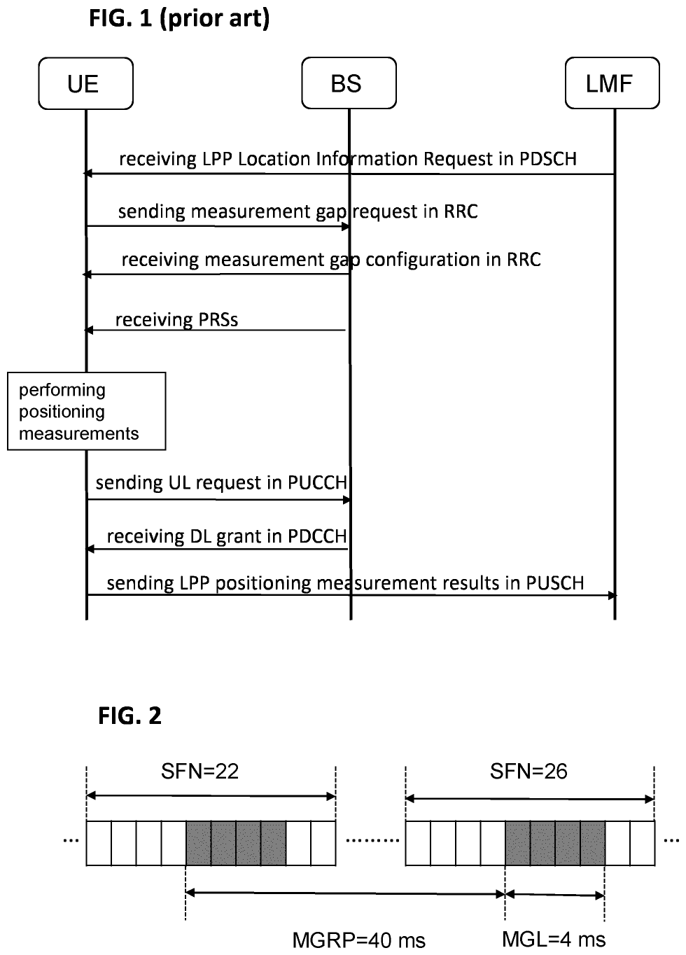

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques which facilitate positioning of UEs are described. Such techniques provide a means to determine the geographic position and/or velocity of the UE based on measuring radio signals. Position information of the UE may be requested by and reported to a client (e.g., an application) associated with the UE, or by a client within or attached to the core network. The position information may be reported in standard formats, such as those for cell-based or geographical co-ordinates, together with estimated errors (uncertainty) of the position and velocity of the UE and, if available, the positioning method (or the list of the methods) used to obtain the position estimate.

There are many different possible uses for the positioning information. The positioning functions may be used internally by communication systems, such as LTE systems or 5G systems, by value-added network services, by the UE itself or through the network, and by “third party” services. The feature may also be used by an emergency service (which may be mandated or “value-added”), but the location service is not exclusively for emergencies.

The techniques disclosed herein disclose aspects with respect to a PP that facilitates positioning at low latency. The PP provides for a framework to facilitate low-latency positioning measurements.

The techniques described herein generally rely on the transmission of PRSs. Various implementations of PRSs are conceivable. For example, PRSs may be transmitted in in the downlink (DL) or in the uplink (UL). According to the disclosure, DL-based positioning and/or UL-based positioning can be used. For instance, sounding reference signals (SRSs) in the UL may implement the PRSs.

For DL positioning: The PRSs are transmitted by multiple ANs (e.g., ANs) and can be received by a target UE to be positioned. On the other hand, for the UL positioning, the UL reference signals, e.g., SRS, are transmitted by the target UE to be positioned and can be received by multiple ANs. The PRSs and the SRSs can be both called positioning signals or reference signals in this disclosure and the DL PRSs and generally DL positioning will be used as an example to describe this disclosure hereinafter, but similar techniques may also be applicable to UL positioning.

According to various examples described herein, transmission of the PRSs may be implemented on a wireless link on which also transmission of further signals is implemented. In particular, the further signals may encode, e.g., control messages or payload messages. The wireless link may operate according to a transmission protocol. For example, the transmission protocol may employ Orthogonal Frequency Division Multiplex (OFDM) modulation. Here, a carrier comprises multiple subcarrier and one or more associated time-frequency resource grids are defined. For example, the transmission protocol may be associated with a RAN of a cellular network; here, the ANs can be implemented by ANs of the RAN.

According to the various techniques described herein, the positioning may employ a multilateration and/or multiangulation technique based on one or more receive properties of the PRSs transmitted by multiple ANs. It would be possible that the logic for implementing said positioning partly or fully resides at the UE to be positioned, and/or partly or fully resides at an LS, e.g., implemented by an LMF. For example, it would be possible that the UE reports raw measurement data associated with the one or more receive properties of the PRSs to the LS and that the multilateration and/or multiangulation is implemented at the LS. It would also be possible that at least a part of the processing of the multilateration and/or multiangulation etc. is implemented at the UE.

The ANs can have a well-defined position within a reference coordinate system and the target UE can be positioned within the reference coordinate system.

The positioning may generally comprise OTDOA, DL-AOD (Downlink Angle-of-Departure), DL-TDOA (Downlink Time Difference of Arrival), UL-AoA (Uplink Angle-of-Arrival), UL-TDOA (Uplink Time Difference of Arrival).

In the techniques described herein, the concepts of PRS transmission may be combined with concepts of bandwidth parts (BWPs). In general, different BWPs may be employed, depending on the payload size and traffic or signal type, for power saving purposes. For example, the UE can use a narrow BWP for monitoring control channels and only open the full bandwidth of the carrier when a large amount of data is scheduled. According to various examples, a UE receives PRSs on multiple BWPs from multiple ANs. Each BWP is associated with a respective one of the multiple ANs. In another example, a UE receives PRSs on an active BWP of its serving AN (e.g. serving gNB) which also contains the PRSs for multiple ANs (e.g, neighbour gNBs).

The UE while connected to a BS may require a positioning measurement period to perform the one or more measurements of the DL signals, i.e., positioning measurements. The positioning measurement period can include positioning measurement gap: here, other signals encoding data are not scheduled, and the UE can perform the positioning measurement. The positioning measurement period can also include headroom for tuning receive equipment to be able to receive PRSs. The positioning measurement period can include headroom to re-configure digital signal processing equipment in receive chains to be able to receive PRSs and compute the positioning measurement.

As a general rule, the longer the positioning measurement period, which typically comes along with longer measurement gap length, the higher the positioning measurements accuracy. On the other hand, the longer the positioning measurement period the higher the positioning measurement's latency. In this disclosure, the (low) latency may be generally related to the whole positioning procedure of the UE and may be particularly related to the positioning measurements, e.g., performing measurements of DL PRS RSRP and/or DL PRS RSTD. I.e., the terminology “low-latency” may, at least in parts, refer to performing the positioning measurements in a short positioning measurement period.

Beyond the positioning measurement period, there are other contributions to an increased latency of UE positioning. In further details, various examples are based on the finding that major latency contributions comprise the duration of the positioning measurement (i.e., the positioning measurement period) by the UE, but also the triggering of the UE positioning measurement. Latency contributions include DL PRS alignment, transmission, measurement (including processing time), and reporting delay; measurement gap request, configuration, and alignment time; UE/BS higher layer (LPP/RRC) processing time. In general, the positioning procedure where the UE is required to request a positioning measurement period, receive a positioning measurement period configuration, and perform the measurement may typically result in hundreds of ms in latency. This is a relatively substantial amount of physical layer latency and cannot fulfill the requirements of various low-latency use-cases of 5G.

The techniques described herein rely on one or more configurations of a positioning measurement that are pre-emptively provided to or otherwise obtained (established) at the UE to facilitate the positioning measurement of a UE connected to a cellular network. Pre-emptively establishing can refer to establishing the one or more configurations prior to a concrete need for a positioning measurement. Pre-emptively establishing can pertain to establishing the one or more configurations before a positioning measurement period is initiated or known. Thus, the one or more configurations can be established independent of the concrete positioning measurement duration. Thus, the one or more configurations may be referred to as one or more pre-configurations.

The UE establishes the one or more pre-configurations of the positioning measurement in advance and only then establishes a positioning measurement period for performing the positioning measurement, e.g., defines a timing of the positioning measurement period. The one or more pre-configurations of the positioning measurement may be established without reference to the positioning measurement period. I.e., the one or more pre-configurations are independent of the positioning measurement periods and generic for one or more, or even all, of the potentially upcoming positioning measurement periods. Thereby, during the positioning measurement period, the UE participates in the positioning measurement in accordance with the one or more pre-configurations. The latency is reduced, because the one or more configurations—typically of significant size—are readily available as the positioning measurement period advances.

According to various examples, the one or more pre-configurations of the positioning measurement may be established having a limited validity; i.e., the one or more pre-configurations may only be applicable for a certain amount and/or type of positioning measurement periods. For example, the one or more pre-configurations may be positioning measurement period-dependent and only used for the one or more pre-determined positioning measurement periods. Here, the one or more positioning measurement periods may be predetermined however without being specified in concrete terms when obtaining the one or more pre-configurations. For example, the one or more pre-configurations are valid for a single next positioning measurement period.

According to various examples, the one or more pre-configurations of the positioning measurement may be defined by a network node of the cellular network, such as an AN or an LS (e.g., implemented by the LMF). In such a scenario, the UE establishing the one or more pre-configurations of the positioning measurement may comprise obtaining the one or more pre-configurations from a network node of the cellular network, for example in a message native to an RRC Layer. The message may be communicated on a PDSCH. The message may be provided by the AN serving the UE or the LS. Alternatively or optionally, the AN provides the supported pre-configurations to an LS. Subsequently, the LS provides the information on supported pre-configurations to the UE via the LPP protocol.

Alternatively or optionally, the one or more pre-configurations of the positioning measurement may be defined by the UE itself, i.e., without any assistance from the cellular network, and thereby the UE establishes the one or more pre-configurations of the positioning measurement may comprise loading and/or activating the one or more pre-configurations from a local memory of the UE. The one or more pre-configurations may be specified by a communication protocol, e.g., the PP. The one or more pre-configurations may be loaded depending on certain state variables, e.g., a required latency of an application, a coverage state etc.

According to this disclosure, the one or more pre-configurations of the positioning measurement may be defined in accordance with a latency requirement associated with the positioning measurement and/or a capability of the UE to support the positioning measurement having a latency level and/or a latency level associated with the latency requirement and/or accuracy of the positioning measurement. The latency requirement and/or the latency level associated with the latency requirement and/or the accuracy of the positioning measurement may be received from applications, i.e., Apps, running on the UE, nodes of the cellular network, or applications running on a server connected to the cellular network, such as a cloud computing server or an edge computing server. For example, the UE may receive an indication from the Application layer that a low-latency positioning measurement is requested and the UE may, based on the received indication, provide, to the cellular network, a request indicative of a latency requirement associated with the positioning measurement, i.e., the requested low-latency positioning measurement from the application layer. Then, the AN or the LS may provide the suitable one or more pre-configurations. It would also be possible that the UE loads the appropriate one or more pre-configurations, e.g., pre-determined according to the PP.

An example implementation of such pre-configurations is illustrated in TAB. 1 below.

TABLE 1
Exemplary Pre-configurations. Table 1 shows examples of the
pre-configurations of the positioning measurement P1-P6.

| Pre- | | | | | Capability | | | |
|---|---|---|---|---|---|---|---|---|
| configuration | Latency | | | Capability of UE | of network | Accuracy | | |
| Index | requirement | | Latency level | (Support or not) | (Support or not) | of measurement | | Latency mode |
| P1 | <10 | ms | Level 1 | No | Yes | >10 | m | low |
| P2 | 10-20 | ms | Level 2 | Yes | Yes | 5-10 | m | |
| P3 | 20-30 | ms | Level 3 | Yes | Yes | 2-5 | m | |
| P4 | 30-50 | ms | Level 4 | Yes | Yes | 1-2 | m | |
| P5 | 50-100 | ms | Level 5 | Yes | Yes | 50-100 | cm | normal |
| P6 | >100 | ms | Level 6 | No | No | <50 | cm | |

As a general rule, the UE establishing the one or more pre-configurations of the positioning measurement may comprise establishing one of, multiple of, or all of the pre-configurations P1-P6. The pre-configuration index is associated with the required latency. Optionally, it can also be associated with the required positioning accuracy as shown in Table 1. For example, when the one or more pre-configurations are positioning measurement period-dependent, the UE may establish one pre-configuration, e.g., P1, P2, or P3, based on a latency requirement, which is, for example, less than 30 ms. As a further example, the UE may establish one pre-configuration P3 based on the latency requirement, less than 30 ms, and an accuracy of measurement, less than 6 m. Such a pre-configuration P3 can fulfill the latency requirement while obtaining an accuracy of measurement as high as possible. Furthermore, the pre-configuration index is associated with the number of PRS resources/positioning samples to be used for positioning measurement. A lower number of PRS resources represents a low latency positioning measurement.

Alternatively or optionally, the one or more pre-configurations may be established/obtained based on a capability of the UE. For example, as shown in Table 1, the UE does not support the latency requirements of less than 10 ms and more than 100 ms, respectively. The UE may provide, to the cellular network, such capability information. Thus, when a node of the network defines (i. e, configures/determines) the one or more pre-configurations, the pre-configurations P1 and P6 will be not applicable to the UE, but may be applicable for other UEs. In general, the specific latency requirements P1-P6 may be mapped to corresponding latency levels 1-6 and the one or more pre-configurations may be established based on the latency level. When the one or more pre-configurations are independent of the positioning measurement periods and generic for multiple or even all of the positioning measurement periods, the UE may establish all possible pre-configurations, e.g., P1-P6, and select one or more pre-configurations from P1-P6 based on a specific latency requirement and/or a latency level associated with the latency requirement and/or accuracy of the positioning measurement, e.g., associated with a specific use-case. I.e., a list of candidate configurations is narrowed down.

According to various examples, the one or more pre-configurations of the positioning measurement may be alternatively or optionally defined in accordance with a capability of the network, such as ANs and/or LS/LMF, to support the positioning measurement having a latency level. The UE may obtain, from the cellular network, such a capability of the cellular network to support a low-latency positioning mode in accordance with the one or more pre-configurations as shown in TAB. 1.

According to various examples, the different latency requirements and/or the different latency levels depicted in TAB. 1 may be classified into two latency modes, i.e., low- and normal-latency modes. Thereby, the pre-configurations P1-P4 are generally associated with a low-latency positioning mode and specifically associated with a low-latency positioning measurement mode. The pre-configurations P5 and P6 are associated with a normal-latency mode. In some other examples, the normal-latency mode may be replaced by the legacy mode/approach. Accordingly, the pre-configurations P5 and P6 can be removed from TAB. 1. I.e., the pre-configurations may be only defined/configured for low-latency mode. Otherwise, legacy operations are applied. This can reduce latency incurred by selecting one or more suitable pre-configurations from, for example, P1-P4 of TAB. 1 and thereby facilitate positioning measurements with low-latency.

According to this disclosure, different ones of the multiple pre-configurations may be associated with different latency levels and/or positioning accuracies of the positioning measurement, such as P1-P6 of Table 1.

According to various examples, each one of the one or more pre-configurations may be indicative of a measurement gap length. The measurement gap length may be indicative of a time duration during which the UE suspends its communication with serving cell to measure intra and/or inter frequency neighbors or other RAT neighbors. During the measurement gap, PUSCH and PDSCH may not be scheduled for the UE.

Optionally, at least one configuration of the one or more pre-configurations may have a measurement gap length which is shorter than a duration of a resource set of positioning signals of the positioning measurement, e.g. PRSs. This means that the UE may not receive all available PRSs, but rather limit itself to a subset of the PRSs at the respective measurement time duration, so as to reduce latency. The UE may already commence along the next steps of the PP while PRSs are still being transmitted.

Alternatively or optionally, each one of the one or more pre-configurations may be indicative of at least one timing parameter of a measurement gap for monitoring positioning reference signals transmitted by one or more network nodes of the cellular network. The at least one timing parameter may be selected from the group comprising: a measurement gap length (MGL), a measurement gap repetition period (MGRP), a measurement gap offset, a measurement gap timing advance (MGTA). Detailed descriptions related to MGL, MGRP, gap offset, and MGTA are described in Table 2.

TABLE 2
Detailed descriptions related to MGL, MGRP,
gap offset, and MGTA according to examples.

| Parameter | Description |
|---|---|
| measurement gap | It is the length of the measurement gap in ms. Measurement |
| length (MGL) | gap lengths may be, such as 0.5 ms, 1 ms, 1.5 ms, 3 ms, 3.5 |
| | ms, 4 ms, 5.5 ms and 6 ms. |
| measurement gap | It defines the periodicity (in ms) at which the measurement gap |
| repetition period | repeats (or is repeated). For example, it can be configured as |
| (MGRP) | 20, 40, 80, 160 ms, or N/A. In some examples, the current |
| | measurement gap may be performed right after the previous |
| | measurement gap, i.e., the MGRP is configured as being equal |
| | to the MGL. |
| measurement gap | It can be defined as the offset of the gap pattern. There are |
| offset | about 160 offset values, but all values are not applicable for all |
| | periodicities. The offset values points to the starting subframe |
| | within the measurement gap period, its value range is from 0 to |
| | MGRP - 1. For example, if the periodicity is 20 ms, the offset |
| | ranges from 0 to 19 ms. |
| measurement gap | If this is configured, the UE starts the measurement MGTA ms |
| timing advance | before the gap subframe occurrence, i.e., the measurement gap |
| (MGTA) | starts at time MGTA ms advanced to the end of the latest |
| | subframe occurring immediately before the measurement gap. |
| | The amount of timing advance may be, for example 0.25 ms in |
| | Frequency Range 2 (FR2) or 0.5 ms in Frequency Range 1 |
| | (FR1). |

The UE may determine measurement gap timing based on gapOffset, MGRP, and/or MGL provided by, for example, the network. FIG. 2 is an exemplary configuration of a measurement gap, in which gapOffset=24, MGRP=40 ms, MGL=4 ms. The first subframe of each measurement gap occurs at a System Frame Number (SFN) and a subframe meeting the following condition:

$$SFN mod ( MGRP / 10 ) = FLOOR ( gapOffset / 10 ) \\ Subframe = gapOffset mod 10$$

So the SFN for measurement gap can be 6, 10, 14, 18, 22, 26, and etc. starting at subframe 4 during the measurement length period of 4 ms as shown in FIG. 2.

According to various examples, the at least one timing parameter may be indicative of a timing constraint in accordance with which a timing of said participating in the positioning measurement is set. This means that the at least one timing parameter may specify upper or lower bounds for one or more of the parameters as indicated in TAB. 2 above. The UE may then be free to choose the concrete value of the timing parameter in accordance with the respective constraint. For instance, the UE would be able to shorten the measurement gap, e.g., if a sufficient number of PRS have been received and/or if they have been received at a sufficient quality, i.e., if the situation permits. Thereby, the logic for configuring the timing of the measurement gap can be distributed between the cellular network and the UE. Thereby, it is possible to shorten the latency of the positioning, by enabling the UE to shorten the positioning measurement where possible.

According to various examples, each one of the one or more pre-configurations may be indicative of resources allocated to PRSs of the positioning measurement. For instance, time-frequency resources in a time-frequency resource grid defined in accordance with an OFDM modulation may be indicated. Symbols and/or subcarriers may be indicated. Physical resource blocks may be indicated. One or more BWPs may be indicated. These time-frequency resources can be relatively indicated, e.g., with respect to the beginning of a subframe of a measurement gap or, generally, with respect to a timing reference of the respective positioning measurement period. It would also be possible that reoccurring resources are indicated. For instance, resources allocated to the PRSs may be persistently or semi-persistently scheduled. They may be reoccurring over time, e.g., every N-th subframe. Thereby, it is possible to provide the one or more pre-configurations without reference to the specific positioning measurement period, while still indicating the resources. Then, it may not be required to indicate the resources in advance of the concrete positioning measurement period, which facilitates reduction of the latency.

Alternatively or optionally, the one or more pre-configurations may be indicative of one or more resource sets allocated to the PRSs, one or more frequency layers, and/or one or more BWPs of the PRSs. For example, in a low-latency mode, the ANs may transmit PRSs using shorter resource sets, while, in a high-latency mode, the ANs may transmit PRSs using longer resource sets. Therefore, the latency requirements can be further fulfilled by adjusting the duration of resources for transmitting PRSs.

Additionally or optionally, when, for example, the PRSs transmitted from different ANs, such as multiple neighboring access nodes and the serving access node, can be measured within the same UE active BWP, the one or more pre-configurations may be indicative of resources allocated to positioning signals transmitted by multiple ANs of the cellular network.

The techniques described in this disclosure utilize the one or more pre-configurations of a positioning measurement to facilitate the positioning measurement of a UE connected to a cellular network. In particular, the latency incurred in performing the positioning measurement can be adaptively adjusted by selecting one or more appropriate pre-configurations, for example by configuring a short positioning measurement period. Such techniques may be applied to 5G communication systems and facilitate the performance of such communication systems.

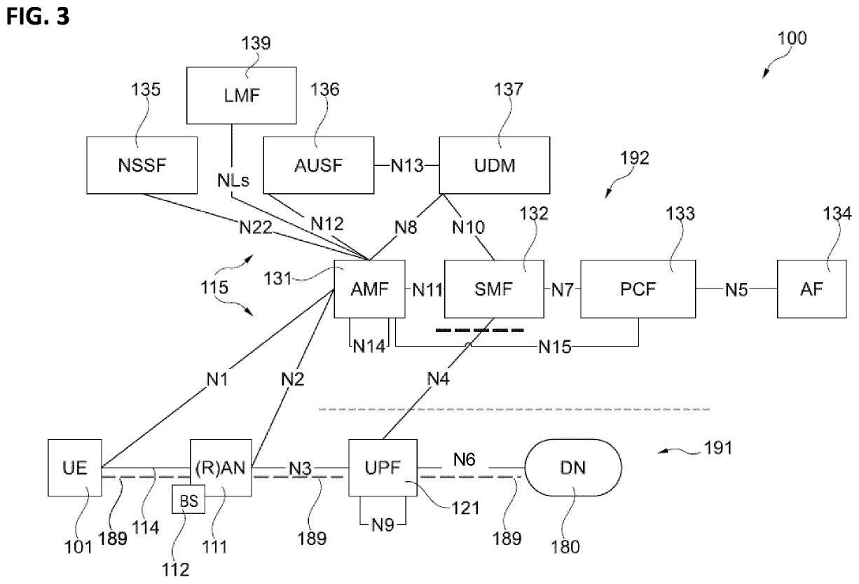

FIG. 3 schematically illustrates a cellular network 100. The example of FIG. 3 illustrates the network 100 according to the 3GPP 5G architecture. Details of the 3GPP 5G architecture are described in 3GPP TS 23.501, version 1.3.0 (2017-09). While FIG. 2 and further parts of the following description illustrate techniques in the 3GPP 5G framework of a cellular network, similar techniques may be readily applied to other communication networks. Examples include e.g., an IEEE Wi-Fi technology.

In the scenario of FIG. 3, a UE 101 is connectable to the cellular network 100. For example, the UE 101 may be one of the following: a cellular phone; a smart phone; and IoT device; a MTC device; a sensor; an actuator; etc.

The UE 101 is connectable to the network 100 via a RAN 111, typically formed by one or more ANs 112 (only a single BS 112 is illustrated in FIG. 3 for the sake of simplicity; the BSs implement ANs). A wireless link 114 is established between the RAN 111—specifically between one or more of the BSs 112 of the RAN 111—and the UE 101. The wireless link 114 is defined by one or more OFDM carriers.

The RAN 111 is connected to a core network (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 3, the UPF 121 acts as a gateway towards a data network 180, e.g., the Internet or a Local Area Network. Application data can be communicated between the UE 101 and one or more servers on the data network 180.

The network 100 also includes an Access and Mobility Management Function (AMF) 131; a Session Management Function (SMF) 132; a Policy Control Function (PCF) 133; an Application Function (AF) 134; a Network Slice Selection Function (NSSF) 135; an Authentication Server Function (AUSF) 136; a Unified Data Management (UDM) 137; and a Location Management Function (LMF) 139. FIG. 3 also illustrates the protocol reference points N1-N22 between these nodes.

The AMF 131 provides one or more of the following functionalities: registration management; non-access stratum (NAS) termination; connection management; reachability management; mobility management; access authentication; and access authorization. A data connection 189 is established by the AMF 131 if the respective UE 101 operates in a connected mode.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 via the RAN 111 and the data plane 191 of the CN 115 and towards the DN 180. For example, a connection with the Internet or another packet data network can be established. To establish the data connection 189, it is possible that the respective UE 101 performs a random access (RACH) procedure, e.g., in response to reception of a paging indicator or paging message and, optionally, a preceding wake up signal. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the Operating Systems Interconnection (OSI) model of Layer 2.

The LMF 139 implements a LS. The LMF 139 handles location service requests. This may include transferring assistance data to the target UE 101 to be positioned to assist with UE-based and/or UE-assisted positioning and/or may include positioning of the target UE. See 3GPP TS 38.305 V15.3.0 (2019-03), section 5.1. For DL positioning using PRSs, the LMF 139 may instigate location procedures using a positioning protocol with the UE 101—e.g. to obtain a location estimate or positioning measurements or to transfer location assistance data to the UE 101. The LMF 139 can transmit a configuration regarding BWPs to the UE 101. The LMF 139 can determine one or more pre-configurations for positioning of the UE 101. The LMF 139 can provide the one or more pre-configurations to the UE 101.

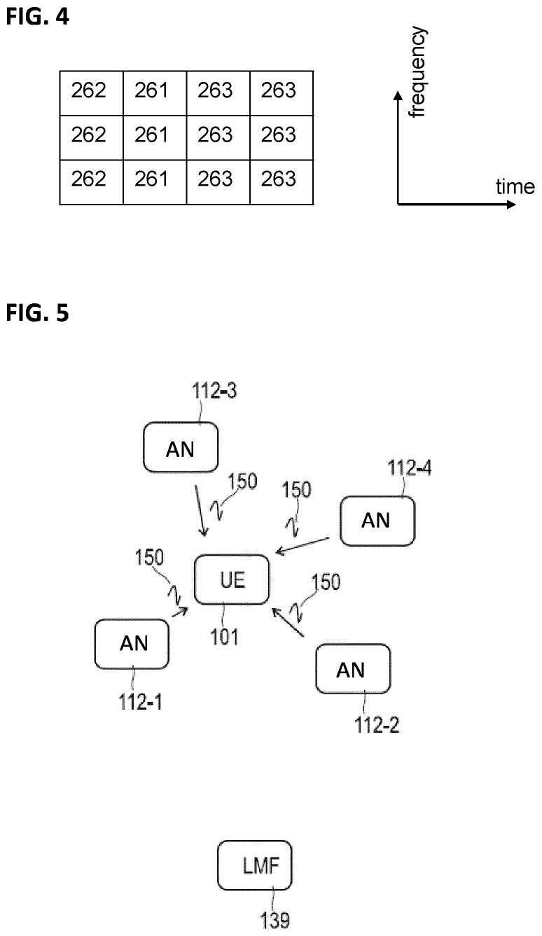

FIG. 4 illustrates aspects with respect to channels 261-263 implemented on the wireless link 114. The wireless link 114 implements a plurality of channels 261-263. The resources of the channels 261-263 are offset from each other, e.g., in frequency domain and/or time domain, in accordance with a respective resource mapping. The resources may be defined in a time-frequency grid defined by the symbols and subcarriers of the OFDM modulation of the carrier.

A first channel 261 may carry PRSs.

A second channel 262 may carry Layer 1 (PHY layer) control messages. Such control messages may be parsed by processes implemented natively on Layer 1. Thus, higher-NAS may not be involved in communication of such control messages on Layer 1. This generally reduces latency, e.g., when compared to channels that carry higher-layer control messages. For instance, the channel 262 may implement PDCCH or PUCCH.

Here, scheduling information for PUSCH or PDSCH may be communicated on the channel 262. A specific pre-configuration of positioning may be activated, e.g., by communicating a respective pointer.

Further, a third channel 263 is associated with payload messages carrying higher-layer user-plane data packets associated with a given service implemented by the UE 101 and the BS 112 (payload channel 263). The channel 263 may implement PUSCH or PDSCH. User-data messages may be transmitted via the payload channel 263. For instance, RRC messages may be communicated. Generally, more data can be accommodated in such higher-layer messages; on the other hand, since a plurality of functions on different layers of a transmission protocol stack are involved, typically, the latency required for communicating such RRC messages, etc. is comparably large.

For example, a configuration of BWPs used for PRS transmission may be included in the control messages of the PP. For instance, one or more pre-configurations may be communicated on the third channel 263.

FIG. 5 schematically illustrates aspects with respect to DL positioning techniques for a target UE 101 to be positioned. Multiple ANs 112-1-112-4 transmit DL PRSs 150 and the UE 101 receives the PRSs 150. Herein, the ANs 112-1-112-4 may be multiple base stations (BSs), such as, eNBs, gNBs, or TRPs (Transmission and Reception Points). Then, the UE 101 can participate in positioning, for example participating in the positioning measurement. This can include determining one or more receive properties of the PRSs 150, determining a TOA of the PRSs 150, determining a TDOA of the PRSs 150, and/or performing multilateration and/or multiangulation based on the TDOA (in the case of UE-based positioning). At least some of these tasks can also be performed by the LMF 139 or, more generally, an LS. LMF performs multilateration and/or multiangulation based on the received positioning measurement (in the case of UE-assisted positioning).

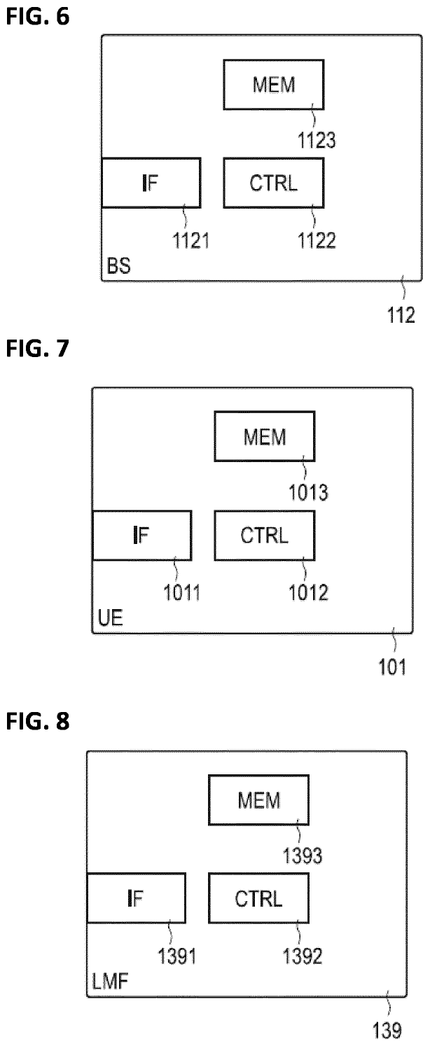

FIG. 6 schematically illustrates the BS 112. For example, the BSs 112-1-112-4 could be configured accordingly. The BS 112 includes an interface 1121. For example, the interface 1121 may include an analog front end and a digital front end. The interface 1121 can support multiple signal designs, e.g., different modulation schemes, coding schemes, modulation numerologies, and/or multiplexing schemes, etc. Multiple BWPs are supported. The BS 112 further includes control circuitry 1122, e.g., implemented by means of one or more processors and software. For example, program code to be executed by the control circuitry 1122 may be stored in a non-volatile memory 1123.

In the various examples disclosed herein, various functionality may be implemented by the control circuitry 1122, e.g., transmitting PRSs; establishing one or more pre-configurations of a positioning measurement for the UE 101; after establishing the one or more pre-configurations, providing, to the UE 101, a measurement grant comprising a pointer to at least one of the one or more pre-configurations and indicative of a positioning measurement period; at the positioning measurement period and in accordance with the at least one of the one or more pre-configurations of the positioning measurement, participating in the positioning measurement; implementing a measurement gap during a positioning measurement period, by not scheduling data on PDSCH and PUSCH; etc.

FIG. 7 schematically illustrates the UE 101. The UE 101 includes an interface 1011. For example, the interface 1011 may include an analog front end and a digital front end. The UE 101 further includes control circuitry 1012, e.g., implemented by means of one or more processors and software. The control circuitry 1012 may also be at least partly implemented in hardware. For example, program code to be executed by the control circuitry 1012 may be stored in a non-volatile memory 1013. In the various examples disclosed herein, various functionality may be implemented by the control circuitry 1012, e.g., establishing one or more pre-configurations of a positioning measurement; after said establishing of the one or more pre-configurations, establishing a positioning measurement period for performing the positioning measurement; in the positioning measurement period and in accordance with the one or more pre-configurations of the positioning measurement, participating in the positioning measurement, e.g., including determining TOAs of the PRSs, determining TDOA, multilateration and/or multiangulation. A positioning measurement's latency may be adjusted, i.e., increased or decreased, based on the one or more pre-configurations. A timing of a measurement gap may be adjusted in accordance with one or more constraints imposed by a respective pre-configuration.

FIG. 8 schematically illustrates an LS implemented, in the example of FIG. 8, by the LMF 139. The LMF 139 includes an interface 1391 for communicating with other nodes of the CN 115 or with the RAN 111 of the cellular network 100. The LMF 139 further includes control circuitry 1392, e.g., implemented by means of one or more processors and software. For example, program code to be executed by the control circuitry 1392 may be stored in a non-volatile memory 1393. In the various examples disclosed herein, various functionality may be implemented by the control circuitry 1392, e.g., establishing one or more pre-configurations of a positioning measurement; after said establishing of the one or more pre-configurations, establishing a positioning measurement period for performing the positioning measurement; in the positioning measurement period and in accordance with the one or more pre-configurations of the positioning measurement, participating in the positioning measurement, e.g., including determining TOAs of the PRSs, determining TDOA, multilateration and/or multiangulation.

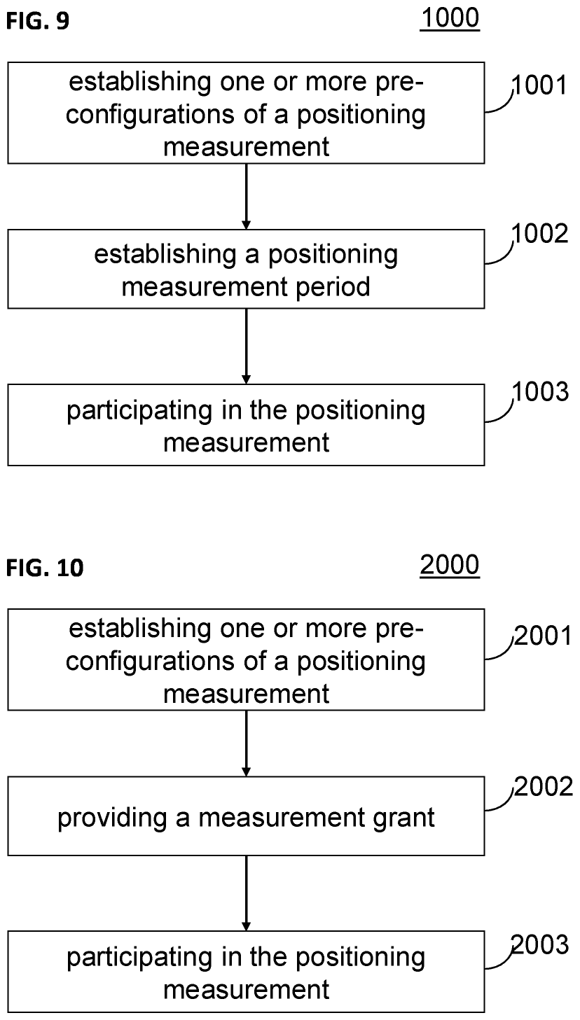

FIG. 9 is a flowchart of a method 1000 according to various examples. The method 1000 can be executed by a UE connected to a communication network, e.g., by the UE 101 of the cellular network 100 (cf. FIG. 3). For example, the method 1000 may be executed by the control circuitry 2002 of the UE 101 upon loading program code from the memory 2003 (cf. FIG. 7). Details of the method 1000 will be described below.

At box 1001, one or more pre-configurations of a positioning measurement are established.

For example, the one or more pre-configurations of the positioning measurement may be defined/configured/determined by a node of the cellular network 100, such as a BS 112, 112-1-112-4 of the RAN 111, the LMF 139 or another node of the cellular network 100, and then may be transmitted to the UE 101. Additionally or optionally, the UE 101 may provide, to the cellular network 100, a request indicative of a latency requirement associated with the positioning measurement, and the one or more pre-configurations are obtained in accordance with the latency requirement. Additionally or optionally, the UE 101 may provide, to the cellular network 100, a capability of the UE 101 to support the positioning measurement having a low latency level, and the one or more pre-configurations are obtained in accordance with the capability of the UE 101.

The capability may pertain to the capability of the UE to implement short positioning measurement periods. The capability may pertain to the capability of the UE to implement L1 signaling for the PP, e.g., to obtain a measurement grant. The capability of the UE may pertain to the capability to determine positioning measurement reports based on only a few received PRS resources/positioning samples, due to shortening the positioning measurement periods.

Alternatively or optionally, the one or more pre-configurations of a positioning measurement may be established by the UE 101 itself. For example, the UE 101 may load/activate the one or more pre-configurations from the memory 2003 of the UE 101. Additionally or optionally, to establish the one or more pre-configurations, the UE 101 may request assistance data of the network 100, such as a capability of the cellular network 100 to support a low-latency positioning mode.

According to various examples, some UEs may support a low-latency positioning mode, while other UEs may only support a legacy positioning mode or a normal positioning mode, and may not support a low-latency positioning mode. A UE that supports a low-latency positioning mode is expected, as things stand, to support the legacy positioning mode too, but this may not always be true. When the one or more pre-configurations of the positioning measurement are associated with a low-latency positioning mode, such as P1-P4 of TAB. 1, the UE 101 may determine whether to support the low-latency positioning mode, for example based on its capability. If it is determined that the UE will support the low-latency positioning mode, the UE 101 may selectively execute the performing of the positioning measurement in accordance with the one or more pre-configurations of the positioning measurement. If it is determined not to support the low-latency positioning mode, the UE 101 may decide to use a legacy positioning measurement method, i.e., a legacy mode, or a normal mode as defined in TAB 1, i.e., P5 and P6.

Additionally or optionally, the determining whether to support the low-latency positioning mode is based on one or more decision criteria. The UE can perform a respective check locally.

The one or more decision criteria may be selected from the group comprising: a periodicity of positioning signals of the positioning measurement, a trigger from higher layer, or network activation of the low-latency positioning mode. For example, the higher layer may be the application layer. The UE 101 may receive a trigger from an application residing on the UE 101, or receive instruction from a further application residing on a node of the network 100, or on a cloud computing server. Alternatively or optionally, the low-latency positioning mode may also be performed when the PRSs transmitted from BSs 112 can be measured within the same UE active BWP. In such a case, the UE 101 may not need to retune the frequency to measure all the PRSs so that a dedicated measurement gap may not be required. The UE does not have to change its RF module, including frequency retuning, bandwidth configuration and numerology, for the PRS reception within UE active BWP. A dedicated measurement gap, as in legacy operations, is required as the UE needs to retune the frequency and update the bandwidth configuration for the PRS reception that may occur in other frequency resources, different numerology, and different bandwidth.

Similar to the UE, some cellular networks may not support the low-latency positioning mode. The UE may thus obtain, from the cellular network 100, a capability of the cellular network 100 to support a low-latency positioning mode in accordance with the one or more pre-configurations. For example, the capability of the cellular network 100 may comprise a capability of each BS connectable to the UE 101, a capability of the LMF 139. If it is determined not to support the low-latency positioning mode the UE 101 may execute the legacy positioning mode/operation. The UE may only select pre-configurations according to the legacy positioning mode.

At box 1002, a positioning measurement period for performing the positioning measurement is established after said establishing of the one or more pre-configurations.

The positioning measurement period may be established with assistance from the network 100. For example, establishing the positioning measurement period may comprise the UE 101 obtaining, from the cellular network 100, a measurement grant comprising a pointer to at least one of the one or more pre-configurations and indicative of the positioning measurement period. Referring to TAB. 1, such a pointer may point to one, multiple or all of the pre-configurations P1-P6. A respective index may be included. The pre-configurations P1-P6 may be sorted based on the corresponding latency requirements or the corresponding latency level. For example, as shown in TAB. 1, the pre-configurations associated with lower latency requirement may be assigned with a smaller index, e.g., P1→level 1 (less than 10 ms). Thus, for example, when the cellular network 100, e.g., a BS 112 or the LMF 139 transmits a measurement grant comprising a pointer, such as less than 4, to the UE 101, the UE 101 may then select any one of the pre-configurations P1-P3 for performing the positioning measurement. Based on the selected pre-configurations P1-P3, the UE may further determine that the latency requirement is less than 30 ms and thereby the positioning measurement period may not be larger than, for example, 3 ms. In other words, the positioning measurement period may be implicitly indicated by the measurement grant. Alternatively or optionally, the measurement grant may explicitly indicate the positioning measurement period by including a specific positioning measurement period into the measurement grant, such as the pointer.

The measurement grant may be included in a control message native to the Physical Layer (L1 layer), or the Medium Access Layer (L2 layer), such that lower latency can be achieved when compared to the RRC layer. The measurement grant may be indicative of time-frequency resources of positioning signals of the positioning measurement, such as the first channel 261 of FIG. 4. Based on the indication of time-frequency resources of positioning signals of the positioning measurement, the UE 101 may determine its time-frequency resources for receiving/monitoring the positioning signals.

According to various examples, to obtain the measurement grant, the UE 101 may provide positioning assistance data to the cellular network 100, e.g., to a BS 112, or to the LMF 139. Then, the measurement grant can be in accordance with the positioning assistance data. The positioning assistance data transfer may be initiated by the UE 101 or by the LMF 139. For example, the UE may send an LPP Provide Assistance Data message comprising the positioning assistance data to the LMF 139. Alternatively or optionally, the LMF 139 may first send an LPP Request Assistance Data message to the UE 101, and then the UE sends an LPP Provide Assistance Data message comprising the positioning assistance data to the LMF 139. The positioning assistance data may comprise at least one of previously selected positioning signal resources, previously best resource, a list of selected neighbor cells, or a list of best neighbor cells.

Establishing the positioning measurement period may optionally or additionally comprise the UE 101 providing a measurement request to the cellular network 101, such as a BS 112 or the LMF 139. For example, the measurement grant may be transmitted in response of the measurement request and the measurement grant may be issued based on the measurement request. The measurement request may be received or triggered by applications, i.e., Apps, running on the UE, and may comprise a latency requirement associated with the positioning measurement. Additionally or optionally, the measurement request is included in a control message native to the Physical Layer or the Medium Access Layer so that lower latency can be achieved when compared to the RRC layer.

Alternatively or optionally, the positioning measurement period may be established by the UE 101 itself. For example, the positioning measurement period may be selected without receiving a measurement grant from the cellular network 100. Specifically, the positioning measurement period for performing the positioning measurement may be autonomously selected by the UE 101 from a plurality of candidate positioning measurement periods. Such candidate positioning measurement periods may be pre-determined based on the timing of the transmissions of PRSs, or received from the network 100. The positioning measurement period may be autonomously selected by the UE 101 in response to at least one trigger criterion being fulfilled. The at least one trigger criterion may be selected from the group comprising: a respective authorization from the cellular network; an off-duration of a discontinuous reception cycle; sufficient PRSs of the positioning measurement being transmitted on an active bandwidth part; or intra-frequency positioning measurements. Herein, “sufficient PRSs” means that the number of PRSs should be sufficient so that the UE can perform positioning measurement with relatively good results, e.g., acceptable latency and/or accuracy. In other words, a sufficient count of PRSs in the frequency domain (e.g., Resource block) and/or time domain (e.g., number of slots/OFDM symbols) can be received by the UE. For instance, there may be a predefined mapping available that specifies the count of PRSs the need to be received under certain coverage scenarios and/or positioning scenario so that the accuracy fulfills a certain predetermined level.

Optionally or additionally, the UE 101 may provide, to the network 100, a request to perform the positioning measurement autonomously and the network 100 may transmit a message indicating a grant of performing the positioning measurement autonomously. Alternatively, the UE 101 may provide, to the cellular network 100, an indication of the UE autonomously selecting the positioning measurement period, e.g., without sending the request to perform the positioning measurement autonomously. Such an autonomously selected positioning measurement period may be selected from positioning measurement period candidates provided by the network 101. For example, the BS 112 may send, to the UE 101, an indication of whether the UE 101 is allowed to perform positioning measurements when it is needed within a certain duration of time. During that duration of time, the UE 101 may perform positioning measurements. That duration of time can be restricted during PRS transmission or specific PRS resource set(s) or PRS resource(s) or a positioning frequency layer. Optionally or additionally, the indication of the UE 101 autonomously selecting the positioning measurement period is included in a control message native to the Physical Layer or Medium Access Layer so that lower latency can be achieved if compared to RRC layer.

At box 1003, the UE participates in the positioning measurement in the positioning measurement period and in accordance with the one or more pre-configurations of the positioning measurement. Said participating in the positioning measurement comprises monitoring for downlink PRSs transmitted by one or more access nodes of the cellular network, or said participating in the positioning measurement comprises transmitting uplink PRSs to one or more access nodes of the cellular network.

According to various examples, each one of the one or more pre-configurations may be indicative of at least one timing parameter of a measurement gap for monitoring PRSs transmitted by one or more network nodes, e.g., BSs 112-1-112-4, of the cellular network 100. For example, the at least one timing parameter may be indicative of a timing constraint and the UE 101 may set a timing of the participating in the positioning measurement in accordance with the timing constraint. The UE may set the duration during which it actually monitors for PRSs autonomously, but compliant with the timing constraint.

The method 1000 may optionally comprise the UE 101 providing, to the cellular network 100, a positioning measurement result after performing the positioning measurement. The positioning measurement result may comprise an indication that the positioning measurement is obtained in accordance with a low-latency positioning mode associated with the one or more pre-configurations. For instance, the particular pre-configuration employed may be indicated. For instance, a respective index may be signaled, cf. TAB. 1.

For example, the positioning measurement with low latency may compromise the positioning accuracy result. It can be the case as the positioning measurement duration/number of samples is typically reduced than the legacy operation. In such a case, it would be beneficial for the LMF 139 to know whether the obtained positioning measurement result is based on a low latency or legacy operation. The UE 101 can provide an indication that the obtained result is based on a low latency positioning measurement. The indication can be in a form of the selected positioning measurement (e.g. the selected adaptive measurement length).

The method 1000 may optionally comprise receiving a request to provide a low-latency positioning measurement result. The request is received from at least one of an application (i.e., App) running on the UE 101, a node of the cellular network 100. In response to the request to provide a low-latency positioning measurement result, the UE 101 may execute the method 1000 from box 1001.

Optionally or additionally, after receiving the request to provide a low-latency positioning measurement result, the UE 101 may determine whether to provide the low-latency positioning measurement result based on at least one of a positioning signal received power, a positioning signal configuration, positioning signal resources, and a capability of nodes of the cellular network supporting the low-latency positioning measurement. For example, if the positioning signal received powers from serving cell or best selected cells are below a pre-defined threshold, and/or if the positioning signal configurations of the serving cell or best selected cells are not possible to perform low latency, e.g. with a long positioning signal periodicity, and/or if the positioning signal resources within an active BWP are relatively smaller than those for obtaining a good accuracy, and/or if the capability of nodes of the cellular network cannot support the low-latency positioning measurement, it is determined not to provide the low-latency positioning measurement result.

If it is determined to not provide the low-latency positioning measurement result, the UE 101 may provide a legacy report or discard the low-latency positioning measurement result. If it is determined not to provide the low-latency positioning measurement result, the method 1000 further comprises: performing the positioning measurement based on a legacy positioning mode.

FIG. 10 is a flowchart of a method 2000 according to various examples. The method 2000 can be executed by a node of a communication network, e.g., by a node of the cellular network 100 (cf. FIG. 3). For example, the method 2000 could be implemented by a BS 112, 112-1-112-4 of the RAN 111; however, it would also be possible that the method 2000 is implemented by the LMF 139 or another node of the cellular network 100. For example, the method 2000 may be executed by the control circuitry 1122 of the BS 112 or the control circuitry 1392 of the LMF 139 upon loading program code from the memory 1123 or 1393, respectively. The method 2000 corresponds a scenario in which the one or more pre-configurations are obtained from a node of the network. Details of the method 2000 will be described below.

At box 2001, one or more pre-configurations of a positioning measurement for a wireless communication device, e.g., the UE 101, are established.

Box 2001 is interrelated to box 1001 of the method 1000 outlined above.

At box 2002, after establishing the one or more pre-configurations, the node provides, to the wireless communication device, a measurement grant comprising a pointer to at least one of the one or more pre-configurations and indicative of a positioning measurement period.

Box 2002 corresponds to a scenario in which a positioning measurement period for performing the positioning measurement is established by the UE after receiving the measurement grant from the network. Box 2002 is interrelated to box 1002 of the method 1000 outlined above.

At box 2003, at the positioning measurement period and in accordance with the at least one of the one or more pre-configurations of the positioning measurement, the node participates in the positioning measurement. Said participating in the positioning measurement comprises monitoring for uplink PRSs transmitted by the target UE connected to the cellular network or transmitting downlink PRSs to the target UE.

The techniques of methods 1000 and 2000 thus enable support positioning measurement with low latency—i.e., the latency incurred in performing the positioning measurement can be adjusted by selecting one or more appropriate pre-configurations, for example by configuring a short positioning measurement period. Such latency can be further reduced by transmitting and/or receiving signaling associated with the positioning measurement via a control message native to the Physical Layer (L1 layer), or the Medium Access Layer (L2 layer). Therefore, the positioning measurement period can be adjusted use-case by use-case while an optimal trade-off between latency and accuracy can be achieved.

As a general rule, the UE 101 can be configured by the LMF 139 and/or the BSs 112-1-112-4; the BSs 112-1-112-4 can be configured by the LMF 139.

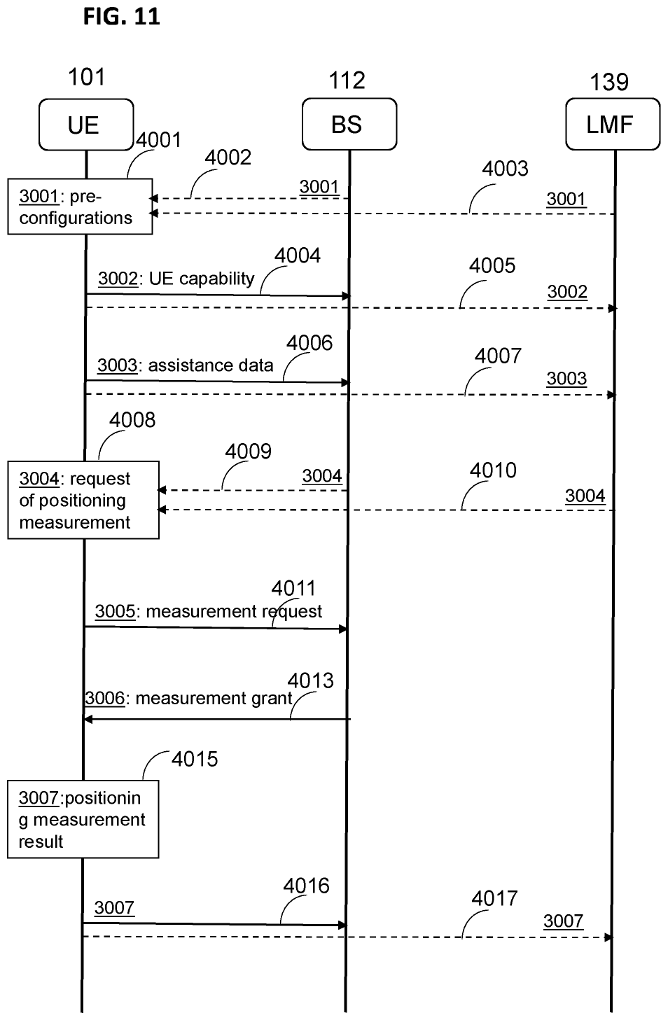

Next, details with respect to such signaling between the various participating entities—e.g., the BS 112, the UE 101, and the LMF 139—are explained in connection with FIGS. 10 and 11, respectively.

FIG. 11 is a signaling flowchart illustrating communication between the BS 112, i.e., the serving BS, of the RAN 111, the LMF 139 and the UE 101. For example, the signaling of FIG. 11 could implement the methods 1000 and 2000.

Alternative operations are indicated by using dash lines. The reference signs starting with 30—indicate data/instructions/messages. On the other hand, the reference signs starting with 40—indicate operations.

Initially, the UE 101 establishes one or more pre-configurations 3001 of the positioning measurement. The one or more pre-configurations 3001 may be defined by the UE 101 at 4001. Alternatively or optionally, the one or more pre-configurations 3001 may be configured by the BS 112, or by the LMF 139, and then transmitted to the UE 101 at 4002 or 4003. For example, the one or more pre-configurations 3001 may be configured by not only the serving BS of the UE 101 but also one or more of neighboring BSs. If the one or more pre-configurations 3001 are configured by one or more of the neighboring BSs, the neighboring BSs may transmitted the one or more pre-configurations 3001 to the LMF 139, and then the LMF 139 may forward the one or more pre-configurations 3001 to the UE 101.

The UE 101 may optionally provide a respective request to the BS 112 or the LMF 139 before 4002, 4003 (not shown). The request can be indicative of a latency requirement, e.g., of an application executed by the UE 101.

Additionally or optionally, the UE 101 provides a capability 3002 of the UE 101 to support the positioning measurement having a low latency level to the BS 112 at 4004, and/or to the LMF 139 at 4005. The capability 3002 could also be provided before 3001—In this case, the pre-configuration 3001 has been tailored to accommodate for UE capability. In examples where the UE capability 3001 is provided before the pre-configuration 3002, the pre-configuration 3002 may be at least partly defined by the UE capability 3001, as discussed above.

Additionally or optionally, the UE 101 provides positioning assistance data 3003 to the BS 112 at 4006, and/or to the LMF 139 at 4007. This could also be implemented before 3001.

Additionally or optionally, the UE 101 receives a request to provide a low-latency positioning measurement result 3004. The request 3004 may be received from applications, i.e., Apps, running on the UE 101 at 4008, or from the BS 112 at 4009, or from the LMF 139 at 4010. The request 3004 transmitted from the BS 112 or the LMF 139 may be received from applications running on a server connected to the cellular network, such as a cloud computing server or an edge computing server.

Next, the UE 101 provides a measurement request 3005 to the BS 112 at 4011, or to the LMF 139. Additionally or optionally, the measurement request 3005 is included in a control message native to the Physical Layer or Medium Access Layer so that lower latency can be achieved when compared to RRC layer. The measurement request 3005 is generally optional.

Next, the UE 101 obtains, from the BS 112 at 4013, a measurement grant 3006 comprising a pointer to at least one of the one or more pre-configurations 3001 and/or indicative of the positioning measurement period. The measurement grant 3006 may be included in a control message native to the Physical Layer (L1 layer), or Medium Access Layer (L2 layer), such that lower latency can be achieved compared to the RRC layer. The UE could also autonomously select the particular pre-configuration and/or positioning measurement period.

The UE 101, at 4015, participates in the positioning measurement in the positioning measurement period and in accordance with the one or more pre-configurations 3001 of the positioning measurement to obtain a positioning measurement result 3007.

Additionally or optionally, the UE 101 provides the positioning measurement result 3007 to the BS 112 at 4016, or to the LMF 139 at 4017.

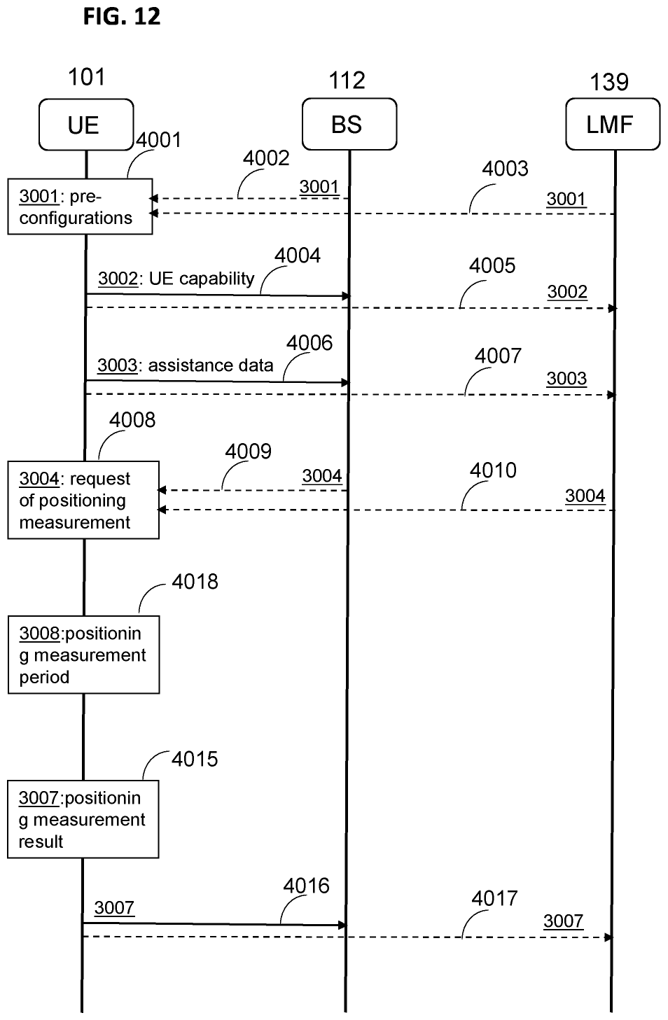

FIG. 12 is a further signaling flowchart illustrating communication between the BS 112 of the RAN 111, the LMF 139 and the UE 101. For example, the signaling of FIG. 12 could implement the methods 1000 and 2000. Most signaling according to FIG. 12 is the same as that according to FIG. 11. The signaling according to FIG. 11 corresponds a scenario in which establishing the positioning measurement period comprises obtaining, from the BS 112 or from the LMF 139, a measurement grant 3006. On the other hand, the signaling according to FIG. 12 corresponds a further scenario in which the positioning measurement period 3008 is selected by the UE 101 itself at 4018 and without receiving a measurement grant 3006 from the BS 112 or the LMF 139.

Summarizing, various techniques disclosed herein enable support positioning measurement with low latency—i.e., the latency incurred in performing the positioning measurement can be adjusted by selecting one or more appropriate pre-configurations, for example by configuring a short positioning measurement period. Such latency can be further reduced by transmitting and/or receiving signaling associated with the positioning measurement via a control message native to the Physical Layer (L1 layer), or Medium Access Layer (L2 layer). Therefore, the positioning measurement period can be adjusted use-case by use-case while an optimal trade-off between latency and accuracy can be achieved.

According this disclosure, the following and other EXAMPLES have been described:

EXAMPLE 1. A method of operating a wireless communication device connected to a cellular network, the method comprising:
establishing one or more pre-configurations of a positioning measurement,
after said establishing of the one or more pre-configurations, establishing a positioning measurement period for performing the positioning measurement, and
in the positioning measurement period and in accordance with the one or more pre-configurations of the positioning measurement, participating in the positioning measurement.

EXAMPLE 2. The method of EXAMPLE 1,
wherein the one or more pre-configurations are established without reference to the positioning measurement period.

EXAMPLE 3. The method of EXAMPLE 1 or 2,
wherein said establishing of the one or more pre-configurations comprises obtaining the one or more pre-configurations from a network node of the cellular network, for example in a message native to a Radio Resource Control Layer.

EXAMPLE 4. The method of EXAMPLE 3,
wherein the one or more pre-configurations are obtained from an access node of the cellular network serving the wireless communication device.

EXAMPLE 5. The method of EXAMPLE 3,
wherein the one or more pre-configurations are obtained from a location server node of the cellular network associated with the positioning measurement.

EXAMPLE 6. The method of any one of EXAMPLEs 3 to 5, further comprising:
providing, to the cellular network, a request indicative of a latency requirement associated with the positioning measurement,
wherein the one or more pre-configurations are obtained in accordance with the latency requirement.

EXAMPLE 7. The method of any one of EXAMPLEs 3 to 6, further comprising:
providing, to the cellular network, a capability of the wireless communication device to support the positioning measurement having a low latency level,
wherein the one or more pre-configurations are obtained in accordance with the capability of the wireless communication device.

EXAMPLE 8. The method of EXAMPLE 1 or 2,
wherein said establishing of the one or more pre-configurations comprises loading the one or more pre-configurations from a local memory of the wireless communication device.

EXAMPLE 9. The method of any one of EXAMPLEs 1-7,
wherein said establishing of the positioning measurement period comprises:
   obtaining, from the cellular network, a measurement grant comprising a pointer to at least one of the one or more pre-configurations and indicative of the positioning measurement period.

EXAMPLE 10. The method of EXAMPLE 9,
wherein the measurement grant is included in a control message native to the Physical Layer or Medium Access Layer.

EXAMPLE 11. The method of EXAMPLE 9 or 10,
wherein the measurement grant is indicative of time-frequency resources of positioning signals of the positioning measurement.

EXAMPLE 12. The method of any one of EXAMPLE s 9 to 11, further comprising:
providing positioning assistance data to the cellular network,
wherein the measurement grant is in accordance with the positioning assistance data.

EXAMPLE 13. The method of EXAMPLE 12,
wherein the positioning assistance data comprises at least one of previously selected positioning signal resources, previously best resource, a list of selected neighbor cells, or a list of best neighbor cells.

EXAMPLE 14. The method of any one of the preceding EXAMPLEs,
wherein said establishing of the positioning measurement period comprises:
providing a measurement request to the cellular network.

EXAMPLE 15. The method of EXAMPLE 14,
wherein the measurement request is included in a control message native to the Physical Layer or Medium Access Layer.

EXAMPLE 16. The method of any one of the preceding EXAMPLEs,
wherein the positioning measurement period for performing the positioning measurement is autonomously selected by the wireless communication device from a plurality of candidate positioning measurement periods.

EXAMPLE 17. The method of EXAMPLE 16,
wherein the positioning measurement period is selected without receiving a measurement grant from the cellular network,
the method optionally comprising:
   providing, to the network, a request to perform the positioning measurement autonomously.

EXAMPLE 18. The method of EXAMPLE 16 or 17,
wherein the positioning measurement period is autonomously selected by the wireless communication device in response to at least one trigger criterion being fulfilled.

EXAMPLE 19. The method of EXAMPLE 18, wherein the at least one trigger criterion is selected from the group comprising: a respective authorization from the cellular network; an off-duration of a discontinuous reception cycle; sufficient positioning reference signals of the positioning measurement being transmitted on an active bandwidth part; or intra-frequency positioning measurements.

EXAMPLE 20. The method of any one of EXAMPLEs 16 to 19, further comprising:
providing, to the cellular network, an indication of the wireless communication device autonomously selecting the positioning measurement period.

EXAMPLE 21. The method of EXAMPLE 20,
wherein the indication of the wireless communication device autonomously selecting the positioning measurement period is included in a control message native to the Physical Layer or Medium Access Layer.

EXAMPLE 22. The method of any one of the preceding EXAMPLEs,
wherein the one or more pre-configurations of the positioning measurement are associated with a low-latency positioning mode,
wherein the method further comprises:
   determining whether to support the low-latency positioning mode, and
   selectively executing said performing of the positioning measurement in accordance with the one or more pre-configurations of the positioning measurement if it is determined to support the low-latency positioning mode.

EXAMPLE 23. The method of EXAMPLE 22,
wherein said determining whether to support the low-latency positioning mode is based on one or more decision criteria,
wherein the one or more decision criteria are selected from the group comprising: a periodicity of positioning signals of the positioning measurement, a trigger from higher layer, or network activation of the low-latency positioning mode.

EXAMPLE 24. The method of any one of the preceding EXAMPLEs,
wherein each one of the one or more pre-configurations is indicative of a measurement gap length,
wherein at least one configuration of the one or more pre-configurations optionally has a measurement gap length which is shorter than a duration of a resource set of positioning signals of the positioning measurement.

EXAMPLE 25. The method of any one of the preceding EXAMPLEs,
wherein each one of the one or more pre-configurations is indicative of at least one timing parameter of a measurement gap for monitoring positioning reference signals transmitted by one or more network nodes of the cellular network.

EXAMPLE 26. The method of EXAMPLE 25,
wherein the at least one timing parameter is selected from the group comprising: a measurement gap length, MGL, a measurement gap repetition period, MGRP, a measurement gap offset, a measurement gap timing advance.

EXAMPLE 27. The method of EXAMPLE 25 or 26,
wherein the at least one timing parameter is indicative of a timing constraint,
wherein the method further comprises:
   setting a timing of said participating in the positioning measurement in accordance with the timing constraint.

EXAMPLE 28. The method of any one of the preceding EXAMPLES,
wherein each one of the one or more pre-configurations is indicative of resources allocated to positioning reference signals of the positioning measurement.

EXAMPLE 29. The method of EXAMPLE 28,
wherein the one or more pre-configurations are indicative of one or more resource sets allocated to the positioning reference signals, one or more frequency layers, and/or one or more bandwidth parts of the positioning reference signals.

EXAMPLE 30. The method of EXAMPLE 28 or 29,
wherein the one or more pre-configurations are indicative of resources allocated to positioning signals transmitted by multiple access nodes of the cellular network.

EXAMPLE 31. The method of any one of the preceding EXAMPLEs,
wherein multiple pre-configurations of the positioning measurement are established,
wherein different ones of the multiple pre-configurations are associated with different latency levels and/or positioning accuracies of the positioning measurement.

EXAMPLE 32. The method of any one of the preceding EXAMPLEs, further comprising
obtaining, from the cellular network, a capability of the cellular network to support a low-latency positioning mode in accordance with the one or more pre-configurations.

EXAMPLE 33. The method of any one of the preceding EXAMPLES,
wherein the one or more pre-configurations are valid for a single next positioning measurement period.

EXAMPLE 34. The method of any one of the preceding EXAMPLEs, further comprising
providing, to the cellular network, a positioning measurement result after performing the positioning measurement,
wherein the positioning measurement result comprises an indication that the positioning measurement is obtained in accordance with a low-latency positioning mode associated with the one or more pre-configurations.

EXAMPLE 35. The method of any one of the preceding EXAMPLEs, further comprising:
receiving a request to provide a low-latency positioning measurement result,
wherein the request is received from at least one of an application running on the wireless communication device, a node of the cellular network.

EXAMPLE 36. The method of EXAMPLE 35, further comprising
determining whether to provide the low-latency positioning measurement result based on at least one of a positioning signal received power, a positioning signal configuration, positioning signal resources, and a capability of nodes of the cellular network supporting the low-latency positioning measurement.

EXAMPLE 37. The method of EXAMPLE 36,
wherein if it is determined not to provide the low-latency positioning measurement result, the method further comprising:
   performing the positioning measurement based on a legacy positioning mode.

EXAMPLE 38. The method of any one of the preceding EXAMPLEs,
wherein said participating in the positioning measurement comprises monitoring for downlink positioning reference signals transmitted by one or more access nodes of the cellular network, or
wherein said participating in the positioning measurement comprises transmitting uplink positioning reference signals to one or more access nodes of the cellular network.

EXAMPLE 39. A method of operating a node of a cellular network, the method comprising:
establishing one or more pre-configurations of a positioning measurement for a wireless communication device,
after establishing the one or more pre-configurations, providing, to the wireless communication device, a measurement grant comprising a pointer to at least one of the one or more pre-configurations and indicative of a positioning measurement period,
in the positioning measurement period and in accordance with the at least one of the one or more pre-configurations of the positioning measurement, participating in the positioning measurement.

EXAMPLE 40. The method of EXAMPLE 39, further comprising:
obtaining, from the wireless communication device, a request indicative of a latency requirement associated with the positioning measurement,
wherein the one or more pre-configurations are obtained in accordance with the latency requirement.

EXAMPLE 41. The method of EXAMPLE 39 or 40, further comprising:
obtaining, from the wireless communication device, a capability of the wireless communication device to support the positioning measurement having a low latency level,
wherein the one or more pre-configurations are obtained in accordance with the capability of the wireless communication device.

EXAMPLE 42. The method of any one of EXAMPLES 39-41,
wherein the measurement grant is included in a control message native to the Physical Layer or Medium Access Layer.

EXAMPLE 43. The method of any one of EXAMPLES 39-42,
wherein the measurement grant is indicative of time-frequency resources of positioning signals of the positioning measurement.

EXAMPLE 44. The method of any one of EXAMPLEs 39 to 43, further comprising:
obtaining positioning assistance data from the wireless communication device, wherein the measurement grant is in accordance with the positioning assistance data.

EXAMPLE 45. The method of EXAMPLE 44,
wherein the positioning assistance data comprises at least one of previously selected positioning signal resources, previously best resource, a list of selected neighbor cells, or a list of best neighbor cells.

EXAMPLE 46. The method of any one of EXAMPLEs 39-45, further comprising:
obtaining a measurement request from the wireless communication device,
wherein the measurement request is included in a control message native to the Physical Layer or Medium Access Layer.

EXAMPLE 47. The method of any one of EXAMPLEs 39-46,
wherein the one or more pre-configurations of the positioning measurement are associated with a low-latency positioning mode,
wherein the method further comprises:
   determining whether to support the low-latency positioning mode, and
      selectively executing said performing of the positioning measurement in accordance with the one or more pre-configurations of the positioning measurement if it is determined to support the low-latency positioning mode.

EXAMPLE 48. The method of any one of EXAMPLES 39-47,
wherein each one of the one or more pre-configurations (3001) is indicative of a measurement gap length,
wherein at least one configuration of the one or more pre-configurations optionally has a measurement gap length which is shorter than a duration of a resource set of positioning signals of the positioning measurement.

EXAMPLE 49. The method of any one of EXAMPLEs 39-48,
wherein each one of the one or more pre-configurations is indicative of at least one timing parameter of a measurement gap for monitoring positioning reference signals transmitted by one or more network nodes of the cellular network.

EXAMPLE 50. The method of any one of EXAMPLEs 39-49,
wherein the at least one timing parameter is selected from the group comprising: a measurement gap length, MGL, a measurement gap repetition period, MGRP, a measurement gap offset, a measurement gap timing advance.

EXAMPLE 51. The method of any one of EXAMPLEs 49-50,
wherein the at least one timing parameter is indicative of a timing constraint,
wherein the method further comprises:
   setting a timing of said participating in the positioning measurement in accordance with the timing constraint.

EXAMPLE 52. The method of any one of EXAMPLES 39-51,
wherein each one of the one or more pre-configurations is indicative of resources allocated to positioning reference signals of the positioning measurement.

EXAMPLE 53. The method of any one of EXAMPLEs 52,
wherein the one or more pre-configurations are indicative of one or more resource sets allocated to the positioning reference signals, one or more frequency layers, and/or one or more bandwidth parts of the positioning reference signals.

EXAMPLE 54. The method of EXAMPLE 52 or 53,
wherein the one or more pre-configurations are indicative of resources allocated to positioning signals transmitted by multiple access nodes of the cellular network.

EXAMPLE 55. The method of any one of EXAMPLES 39-54,
wherein multiple pre-configurations (3001) of the positioning measurement are established,
wherein different ones of the multiple pre-configurations are associated with different latency levels and/or positioning accuracies of the positioning measurement.

EXAMPLE 56. The method of any one of EXAMPLEs 39-55, further comprising
providing, to the wireless communication device, a capability of the cellular network to support a low-latency positioning mode in accordance with the one or more pre-configurations.

EXAMPLE 57. The method of any one of EXAMPLEs 39-56,
wherein the one or more pre-configurations (3001) are valid for a single next positioning measurement period (3008).

EXAMPLE 58. The method of any one of EXAMPLEs 39-57, further comprising
obtaining, from the wireless communication device, a positioning measurement result after performing the positioning measurement,
wherein the positioning measurement result comprises an indication that the positioning measurement is obtained in accordance with a low-latency positioning mode associated with the one or more pre-configurations.

EXAMPLE 59. The method of any one of EXAMPLEs 39-58, further comprising:
providing, to the wireless communication device, a request to provide a low-latency positioning measurement result,
wherein the request is received from at least one of a node of the cellular network.

EXAMPLE 60. The method of any one of EXAMPLEs 39-59,
wherein said participating in the positioning measurement comprises transmitting downlink positioning reference signals to the wireless communication device, or
wherein said participating in the positioning measurement comprises monitoring for uplink positioning reference signals transmitted by the wireless communication device.

EXAMPLE 61. A wireless communication device includes a control circuitry, the control circuitry being configured to execute the method of EXAMPLES 1-38.

EXAMPLE 62. A network node of a network includes control circuitry, the control circuitry being configured to execute the method of EXAMPLES 39-60.

EXAMPLE 63. A system, the system comprising the wireless communication device of EXAMPLE 61 and one or more network nodes of EXAMPLE 62.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For instance, various examples have been described in which an LS implements an LMF to facilitate positioning of a UE. The techniques described herein can also be used in connection with other implementations of the LS.

For further illustration, various examples have been described in connection with implementations of BSs by BSs of a cellular network, the techniques can also be applied to other types of communication systems.

Still further, while various examples have been described in connection with OTDOA or TDOA positioning, other kinds and types of positioning techniques using PRSs may benefit from the techniques described herein. For example, the techniques described herein can also be applied to other measurement method, such as signal strength measurements (e.g., Reference Signal Receive Power, RSRP; or Signal to Interference plus Noise Ratio, SINR).

For still further illustration, various examples have been disclosed in connection with DL positioning, but may also be applied to UL positioning.

1. A method of operating a wireless communication device connected to a cellular network, the method comprising:
establishing one or more pre-configurations of a positioning measurement,
after said establishing of the one or more pre-configurations, establishing a positioning measurement period for performing the positioning measurement, and
in the positioning measurement period and in accordance with the one or more pre-configurations of the positioning measurement, participating in the positioning measurement.

2. The method of claim 1, wherein the one or more pre-configurations are established without reference to the positioning measurement period.

3. The method of claim 1, wherein said establishing of the one or more pre-configurations comprises obtaining the one or more pre-configurations from a network node of the cellular network, for example in a message native to a Radio Resource Control Layer.

4. The method of claim 3, wherein the one or more pre-configurations are obtained from an access node of the cellular network serving the wireless communication device.

5. The method of claim 3, wherein the one or more pre-configurations are obtained from a location server node of the cellular network associated with the positioning measurement.

6. The method of claim 3, further comprising:
providing, to the cellular network, a request indicative of a latency requirement associated with the positioning measurement, wherein the one or more pre-configurations are obtained in accordance with the latency requirement.

7. The method of claim 3, further comprising:
providing, to the cellular network, a capability of the wireless communication device to support the positioning measurement having a low latency level, wherein the one or more pre-configurations are obtained in accordance with the capability of the wireless communication device.

8. The method of claim 1, wherein said establishing of the one or more pre-configurations comprises loading the one or more pre-configurations from a local memory of the wireless communication device.

9. The method of claim 1, wherein said establishing of the positioning measurement period comprises:
obtaining, from the cellular network, a measurement grant comprising a pointer to at least one of the one or more pre-configurations and indicative of the positioning measurement period.

10. The method of claim 9, wherein the measurement grant is included in a control message native to the Physical Layer or Medium Access Layer.

11. The method of claim 9, wherein the measurement grant is indicative of time-frequency resources of positioning signals of the positioning measurement.

12. The method of claim 9, further comprising:
providing positioning assistance data to the cellular network,
wherein the measurement grant is in accordance with the positioning assistance data.

13. The method of claim 12, wherein the positioning assistance data comprises at least one of previously selected positioning signal resources, previously best resource, a list of selected neighbor cells, or a list of best neighbor cells.

14. The method of claim 1, wherein said establishing of the positioning measurement period-comprises: providing a measurement request to the cellular network.

15. The method of claim 14, wherein the measurement request is included in a control message native to the Physical Layer or Medium Access Layer.

16. The method of claim 1, wherein the positioning measurement period for performing the positioning measurement is autonomously selected by the wireless communication device from a plurality of candidate positioning measurement periods.

17. The method of claim 16, wherein the positioning measurement period is selected without receiving a measurement grant from the cellular network, the method optionally comprising:
providing, to the network, a request to perform the positioning measurement autonomously.

18. The method of claim 16, wherein the positioning measurement period is autonomously selected by the wireless communication device in response to at least one trigger criterion being fulfilled.

19. The method of claim 18, wherein the at least one trigger criterion is selected from the group comprising: a respective authorization from the cellular network; an off-duration of a discontinuous reception cycle; sufficient positioning reference signals of the positioning measurement being transmitted on an active bandwidth part; or intra-frequency positioning measurements.

20. The method of claim 16, further comprising:
providing, to the cellular network, an indication of the wireless communication device autonomously selecting the positioning measurement period.

21-63. (canceled)
